(19) United States
(12) Patent Application Publication
(10) Pub. No.: US 2011/0286446 A1
(43) Pub. Date: Nov. 24, 2011

(54) Method and Apparatus for Use in an IP Multimedia

(75) Inventors: Ruth Guerra, Stockholm (SE); Cormac Hegarty, Bromma (SE)

(73) Assignee: TELEFONAKTIEBOLAGET LM ERICSSON (publ), Stockholm (SE)

(21) Appl. No.: 13/147,495

(22) PCT Filed: Feb. 6, 2009
(86) PCT No.: PCT/EP2009/051404

§ 371 Date: Aug. 2, 2011

(51) Int. Cl. H04L 12/66

(52) U.S. Cl. 370/352

(57) ABSTRACT

According to a first aspect of the present invention there is provided a method of routing a call from an IP Multimedia Subsystem network to a circuit switched network. The method comprises, at a circuit switched carrier select node of the IP Multimedia Subsystem network, receiving a session establishment request (S1), determining if the request includes a circuit switched carrier identifier (S2), and, if not, identifying a circuit switched carrier for the intended destination of the request (S4), identifying a gateway control node responsible for a gateway node connected to the circuit switched network of the identified circuit switched carrier (S5), including in the request a circuit switched carrier identifier for the identified circuit switched carrier (S6), and forwarding the request towards the gateway control node (S8).

### TECHNICAL FIELD

The present invention relates to a method and apparatus for use in a IP Multimedia Subsystem, and in particular to a method and apparatus for circuit carrier selection.

### BACKGROUND

IP Multimedia Subsystem (IMS) is the technology defined by the Third Generation Partnership Project (3G) to provide IP Multimedia services over mobile communication networks. IMS provides key features to enrich the end-user person-to-person communication experience through the use of standardised IMS Service Enablers, which facilitate new rich person-to-person (client-to-client) communication. An IMS network is able to connect to both PSTN/ISDN (Public Switched Telephone Network/Integrated Services Digital Network) as well as the Internet.

IMS provides a dynamic combination of voice, video, messaging, data, etc. within the same session. By growing the number of basic applications and the media which it is possible to combine, the number of services offered to the end users will grow, and the inter-personal communication experience will be enriched. This will lead to a new generation of personalised, rich multimedia communication services, including so-called “combinational IP Multimedia” services.

The IMS makes use of the Session Initiation Protocol (SIP) to set up and control calls or sessions between user terminals (or user terminals and application servers). The Session Initiation Protocol is a text-based protocol specified by the Internet Engineering Task Force (IETF) in RFC 3261, similar to Hypertext Transfer Protocol (HTTP) and Simple Mail Transfer Protocol (SMTP), for initiating interactive communication sessions between users. Such sessions include voice, video, chat, interactive games, and virtual reality. Extensions to SIP are also specified in several other IETF specifications.

SIP makes it possible for a calling party to establish a packet switched session to a called party (using so-called SIP User Agents (UA) installed in the User Equipment (UE)) even though the calling party does not know the current IP address of the called party prior to initiating the call. The Session Description Protocol (SDP), carried by SIP signalling, is used to describe and negotiate the media components of the session. Whilst SIP was created as a user-to-user protocol, IMS allows operators and service providers to control user access to services and to charge users accordingly.

FIG. 1 of the accompanying drawings illustrates schematically how the IMS fits into the mobile network architecture in the case of a GPRS/PS access network (IMS can of course operate over other access networks). Call/Session Control Functions (CSCFs) operate as SIP proxies within the IMS. The 3G architecture defines three types of CSCFs: the Proxy CSCF (P-CSCF) which is the first point of contact within the IMS for a SIP terminal; the Serving CSCF (S-CSCF) which provides services to the user that the user is subscribed to; and the Interrogating CSCF (I-CSCF) whose role is to identify the correct S-CSCF and to forward to that S-CSCF a request received from a SIP terminal via a P-CSCF.

Whenever a call originated by an IMS subscriber is to be terminated in a circuit switched network (breakout), the session is routed through a Border Gateway Control Function (BGCF). FIG. 2 of the accompanying drawings illustrates schematically the network architecture required for breakout from the IMS to a circuit switched network. The BGCF decides whether breakout will occur in the current network, or whether a request must first be sent to another IP network before breaking out. If breakout is to occur in the current network, then the signalling is passed to a Media Gateway Control Function (MGCF). Alternatively, if breakout is to occur in another IP network, the request is forward to a BGCF in another network which may then route the request to an MGCF. In order to perform this routing a BGCF will typically make use of a table mapping each destination to a pool of resources, identifying the appropriate MGCF or BGCF towards which the request will be routed.

A MGCF is responsible for interworking with the PSTN; it performs call control protocol conversion between SIP and ISDN User Part (ISUP) or BICC signalling, interfaces with a Signalling Gateway (SGW) and controls the resources in an IMS Media Gateway (IMS-MGW). A SGW interfaces with the signalling plane of a circuit switched network. It transforms lower layer protocols such as Stream Control Transmission Protocol (SCTP) into Message Transfer Part (MTP, an Signalling System 7 (SS7) protocol), to pass ISDN signalling from the MGCF to the circuit switched network. A MGW interfaces with the media plane of the circuit switched network, for example, converting between RTP and PCM.

FIG. 3 illustrates an example of the process implemented by a BGCF to route a call. The steps performed are as follows:
A1. The BGCF receives a request and determines if there is a calling party number. If the calling party number is available, the BGCF performs a best match analysis with the entries in its CallingPartyTable. The result of the analysis is a reference to a CalledPartyTable. If no match is found, or if the calling party number is not available, the default entry in the CalledPartyTable is used.
A2. The BGCF then performs a best match analysis on the CalledPartyTable selected in step A1 using the telephone number of the called user. The result of the analysis is a reference to an entry in the ExternalNetworkPoolsTable. If no match is found, the default entry in the CalledPartyTable is used.
A3. The BGCF then obtains a fully qualified domain name (FQDN) representing a pool of outgoing MGCF's (and their associated SGW's and MGW's) from the entry in the ExternalNetworkPoolsTable identified in step A2. The entry also includes an associated timer value. If the entry contains a trunk group parameter and a trunk context parameter, these parameters are added to the called party number.
A4. The BGCF then performs a DNS lookup using the FQDN identified in step A3 to obtain a list of IP addresses for outgoing MGCFs. The BGCF starts a supervision timer, with the timer value obtained in step A3, and the SIP request is sent to the first outgoing MGCF in the list. The MGCF should respond to the SIP request before the supervision timer expires. If the MGCF does not respond before the timer expires the BGCF then sends the SIP request is sent to the next MGCF in the list

The IMS Specifications (3GPP TS 23.228 and 3GPP TS 24.229) are being updated to include new services referred to as Preferred Circuit Carrier Access and Preferred Circuit Carrier Selection. Preferred Circuit Carrier Access allows the network operator to configure a preferred long distance circuit carrier for a subscriber, set of subscribers or all subscribers on the network. All long distance calls from a subscriber with a preferred circuit carrier are routed to that circuit carrier when preferred circuit carrier access applies. Preferred Circuit Carrier Selection, also known as Dial-around, allows a subscriber to request a long distance circuit carrier for a specific call. A dial-around request is dialed by the subscriber along with the called party number at call origination.

Preferred Circuit Carrier Access and Preferred Circuit Carrier Selection make use of parameter extensions to the tel-URI protocol (using the “parameter” production rule of the tel URI as defined in RFC3966). These parameters are the “cic” and “dia” parameters. The “cic” parameter carries the Carrier Identification Code (CIC) of the preferred long-distance circuit carrier, as defined in RFC4649. When the circuit carrier that has the assigned CIC receives the call, the “dai” (Dial Around Indicator) parameter indicates to that circuit carrier how the “cic” parameter was obtained so that, for example, the circuit carrier can determine whether to charge the user or the operator of the IMS network for the cost of the call transit. The “dai” parameter is defined in IETF draft-yu-tel-dai and the possible values of the “dai” parameter are:
“presub”—indicating “presubscribed; no caller input”;
“presub-da”—indicating “presubscribed; caller input”;
“presub-daUnkwn”—indicating “presubscribed; input by caller undetermined”;
“no-presub”—indicating “no presubscription; caller input”;
“CIC-chrgPty”—indicating “primary preferred carrier of charged party”;
“altClC-chrgPty”—indicating “alternate preferred carrier of charged party”;
“verbal-clgPty”—indicating “selected carrier identification presubscription unknown (verbal) instructions from calling party”;
“verbal-chrgPty”—indicating “selected carrier identification presubscription unknown (verbal) from charged party”; and
“emergency”—indicating “emergency call handling”.

When routing an IMS session request using a tel URI a SIP proxy server, typically the S-CSCF, converts the tel URI to a SIP or SIPS URI using the ENUM protocol defined in RFC 3261. During this translation, the entire telephone-subscriber portion of the tel URI, including any parameters, is placed into the userinfo part of the SIP or SIPS URI, and the “user” parameter set to “phone”. Therefore, when a tel URI including these parameters has been translated to a SIP URI, the “cic” and “dia” parameters will appear in the userinfo part of a SIP or SIPS URI.

Currently, the specifications state that the “cic” and “dai” parametets can be included in the Request-URI of an initial INVITE request by the UE of the calling party if the UE wants to identify a user-dialled carrier. Alternatively, if a BGCF is configured with an operator-assigned circuit carrier, and the BGCF receives a request for which a circuit carrier is required but in which the “cic” parameter has not been populated, the BGCF can populate the “cic” and “dai” parameters appropriately. In addition, the specifications also state that an Application Server (AS) may play a role in support of circuit carrier selection when implementing Preferred Circuit Carrier Selection and Preferred Circuit Carrier Access. Depending on operator policy, an AS may validate the value of an existing “cic” parameter or may insert an appropriate value for the “cic” and/or “dai” parameters when they are not already included (see 3GPP TS 24.229).

A request including the “cic” and “dai” parameters is then routed, by a BGCF, towards the circuit carrier identified by the “cic” parameter. In order to route such a request a BGCF typically has a table mapping each CIC to the appropriate MGCF/BGCF for performing breakout. An MGCF will then be responsible for interworking the “cic” and “dai” parameters to the circuit switched signalling protocol as described in 3GPP TS 29.163. For example, if the outgoing IAM message contains the Transit Network Selection (TNS) parameter, this may be populated using the carrier identification code from the “cic” parameter of the request, and the “dai” parameter can be mapped to the ISUP Carrier Selection Information, as described in 3GPP TS 29.163.

### SUMMARY

According to a first aspect of the present invention there is provided a method of routing a call from an IP Multimedia Subsystem network to a circuit switched network. The method comprises, at a circuit switched carrier select node of the IP Multimedia Subsystem network, receiving a session establishment request, determining if the request includes a circuit switched carrier identifier, and, if not, identifying a circuit switched carrier for the intended destination of the request, identifying a gateway control node responsible for a gateway node connected to the circuit switched network of the identified circuit switched carrier, including in the request a circuit switched carrier identifier for the identified circuit switched carrier, and forwarding the request towards the gateway control node.

The circuit switched carrier identifier may be a Carrier Identification Code. The step of including a circuit switched carrier identifier for the identified circuit switched carrier in the request may comprise including the “cic” parameter in the request-URI of the request, and setting the “cic” parameter to the Carrier Identification Code of the identified circuit switched carrier.

The method may further comprise, at the circuit switched carrier select node, including an indicator that the identified circuit switched carrier included in the request was selected by the operator of the IP Multimedia Subsystem network. This may comprise including the “dai” parameter in the request-URI of the request, and setting the “dai” parameter to “operator”.

The step of identifying a circuit switched carrier for the intended destination of the request may comprises performing a lookup in a database, the database comprising a mapping of destinations to circuit switched carriers. The step of identifying a gateway control node connected to the identified circuit switched carrier may comprise performing a lookup in the database, the database further comprising a mapping of circuit switched carriers to one or more gateway control nodes connected to the circuit switched network of the circuit switched carriers.

The circuit switched carrier select node may be a Border Gateway Control Function. The gateway control node may be a Media Gateway Control Function in the IP Multimedia Subsystem network or, alternatively, a Border Gateway Control Function in another IP Multimedia Subsystem network.

According to a second aspect of the present invention there is provided an apparatus for routing a call from an IP Multimedia Subsystem network to a circuit switched network. The apparatus comprises a receiver for receiving a session establishment request, a processing unit for identifying a circuit switched carrier for the intended destination of the request, identifying a gateway control node responsible for a gateway node connected to the identified circuit switched carrier, including a circuit switched carrier identifier for the identified circuit switched carrier in the request, and a transmitter for forwarding the request towards the identified gateway control node. The apparatus may be a Border Gateway Control Function.

The apparatus may further comprise a database, the database comprising a mapping of destinations to circuit switched carriers. The database may further comprise a mapping of circuit switched carriers to one or more gateway control nodes connected to the circuit switched network of the circuit switched carriers.

### BRIEF DESCRIPTION OF THE DRAWINGS

FIG. 1 illustrates schematically the mobile network architecture of a GPRS/PS access network;

FIG. 2 illustrates schematically the network architecture required for breakout from an IMS network to a circuit switched network;

FIG. 3 illustrates an example of a known process implemented by a BGCF to route a call;

FIG. 4 illustrates an example of the process of implementing a default preferred circuit carrier per destination according to an embodiment of the present invention; and

FIG. 5 illustrates schematically an example of a circuit switched carrier select node according to an embodiment of the present invention.

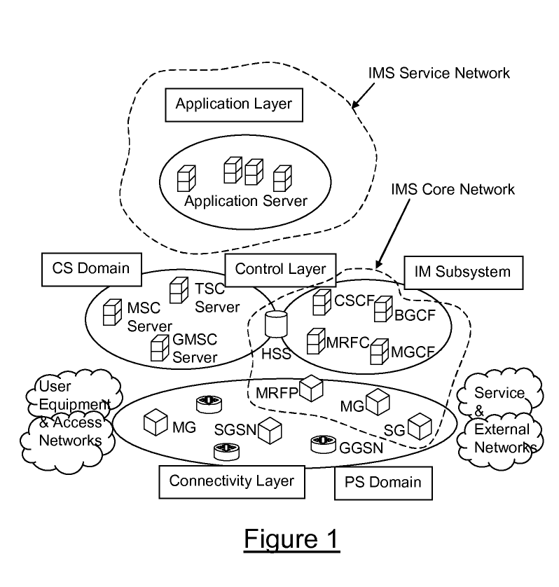

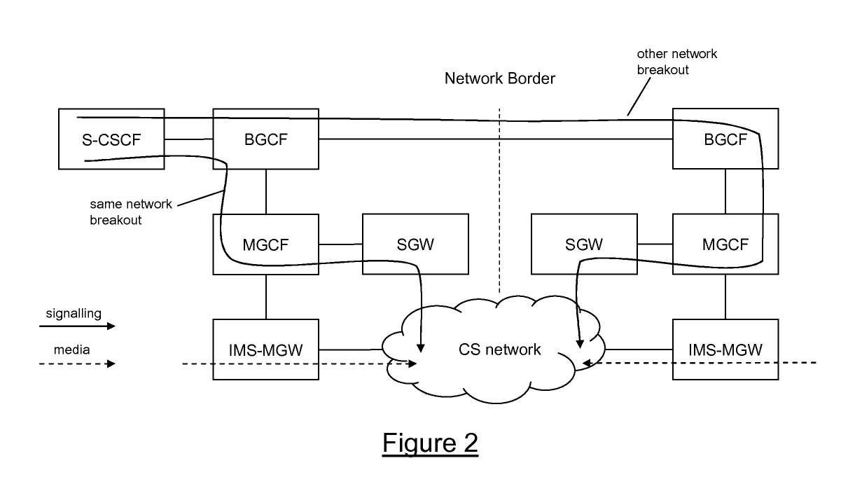

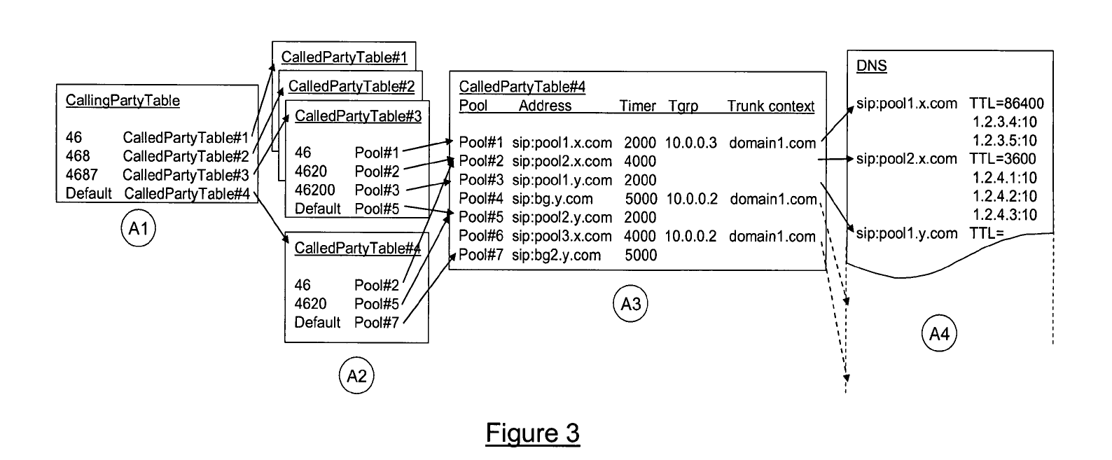

### DETAILED DESCRIPTION

There will now be described a mechanism for providing a default preferred circuit carrier when no preferred circuit carrier has been identified by or for the subscriber, this default preferred circuit carrier being defined by the operator of the network, and determined based on the destination of the call. This enables a network operator to select the lowest cost circuit carrier for calls to particular destinations.

As previously described, specifications such as 3GPP TS 24.229 define that an Application Server (AS) may play a role in support of circuit carrier selection when implementing Preferred Circuit Carrier Selection and Preferred Circuit Carrier Access. If a similar approach is used to implement a default preferred circuit carrier based on the destination of a call, when no preferred circuit carrier has been identified, it would be necessary for such an AS to store data mapping destinations to a CIC identifying the default preferred circuit carrier. The AS would therefore require a large amount of configuration data and processing capacity. In such a case, following the insertion of CIC by an AS, the request would then be forwarded to a BGCF. The BGCF would then be responsible for identifying the pool of resources connected to the circuit switched network identified by the CIC, and routing the request towards this network. As such, the BGCF would also require similar configuration data, mapping each CIC to a pool of resources, and similar processing capacity to that provided in the AS.

It is recognised here that utilising and updating current BGCF functionality to provide support for implementing a default preferred circuit carrier per destination, when no preferred circuit carrier has been identified, avoids the need for additional configuration and processing that would otherwise be required at both a BGCF and an AS.

The method involves, for requests for which a circuit carrier is required but when no preferred circuit carrier has been identified by or for the subscriber, forwarding these requests to a BGCF. The BGCF will then determine the destination, identify the default preferred circuit carrier for that destination and the relevant resources from its mapping table. The BGCF will then include the CIC of the default preferred circuit carrier in the “cic” parameter, set the “dai” parameter to “operator”, indicating that the circuit carrier has been selected by the network operator as required by IETF draft-yu-tel-dai-05, and forward the request to at least one of the identified resources.

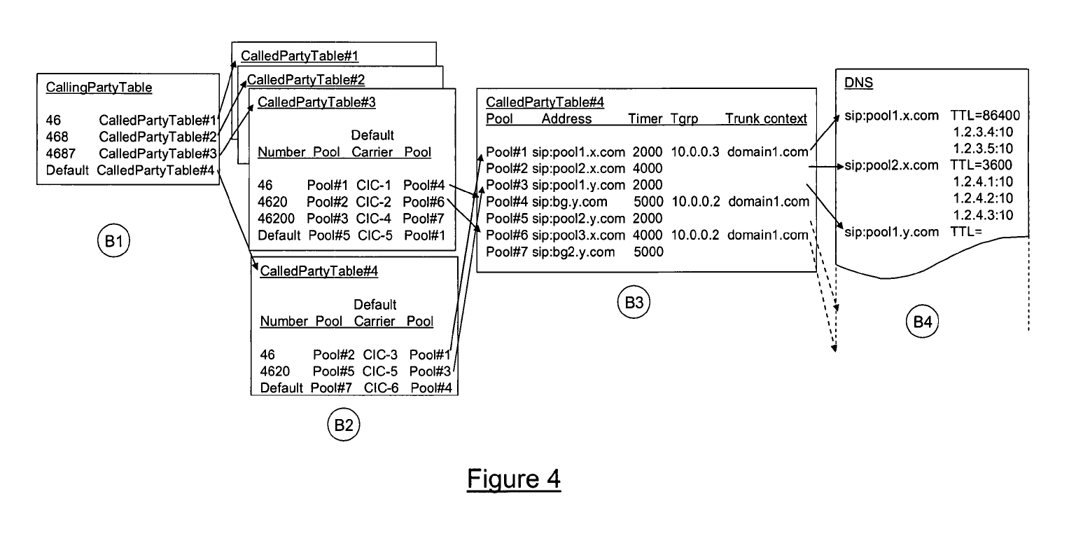

FIG. 4 illustrates an example of the process implemented by a BGCF to identify a default preferred circuit carrier, and the resources attached to the default preferred circuit carrier's network.
B1. The BGCF receives a request and determines if there is a calling party number. If the calling party number is available, the BGCF then determines whether the “cic” parameter has been included in the request, and therefore if a preferred circuit carrier has been identified.
B2. If no preferred circuit carrier has been identified, the BGCF performs a best match analysis with the entries in its CallingPartyTable. The result of the analysis is a reference to a CalledPartyTable.
B3. The BGCF then performs a best match analysis on the CalledPartyTable selected in step B2 using the telephone number of the called user. In this case, the analysis identifies the entry in the CalledPartyTable relating to the called user's telephone number. This entry also includes the default circuit carrier's CIC for that destination and a reference to a separate entry in the ExternalNetworkPoolsTable for that CIC. The BGCF includes the default circuit carrier's CIC value as the “cic” parameter and populates the “dai” parameter with the value “operator”.
B4. The BGCF then obtains a fully qualified domain name (FQDN) representing a pool of outgoing gateway control functions (MGCF/BGCF), responsible for gateways (MGW/SGW) connected to the network identified by the CIC, from the entry relating to the CIC in the ExternalNetworkPoolsTable identified in step B3. The entry also includes an associated timer value.
B5. The BGCF then performs a DNS lookup using the FQDN identified in step B3 to obtain a list of IP addresses for the gateway control functions. The BGCF starts a supervision timer, with the timer value obtained in step B3, and the SIP request is sent to the first gateway control function in the list. The gateway control function should respond to the SIP request before the supervision timer expires.

As an alternative to the process outlined above the ExternalNetworkPoolsTable can contain the IP address of the gateway functions, as opposed to a FQDN, thereby avoiding the need to perform the DNS lookup.

By implementing a default preferred circuit carrier per destination at the BGCF, the method described provides that the identification of a default CIC for a destination and the identification of the associated pool of resources are performed in one step at the BGCF, without the need for additional configuration and logic at an AS. Furthermore, by implementing a default preferred circuit carrier per destination at the BGCF, and not at an AS, the method described avoids the risk of configuration and/or data inconsistencies between the different nodes supporting circuit carrier selection.

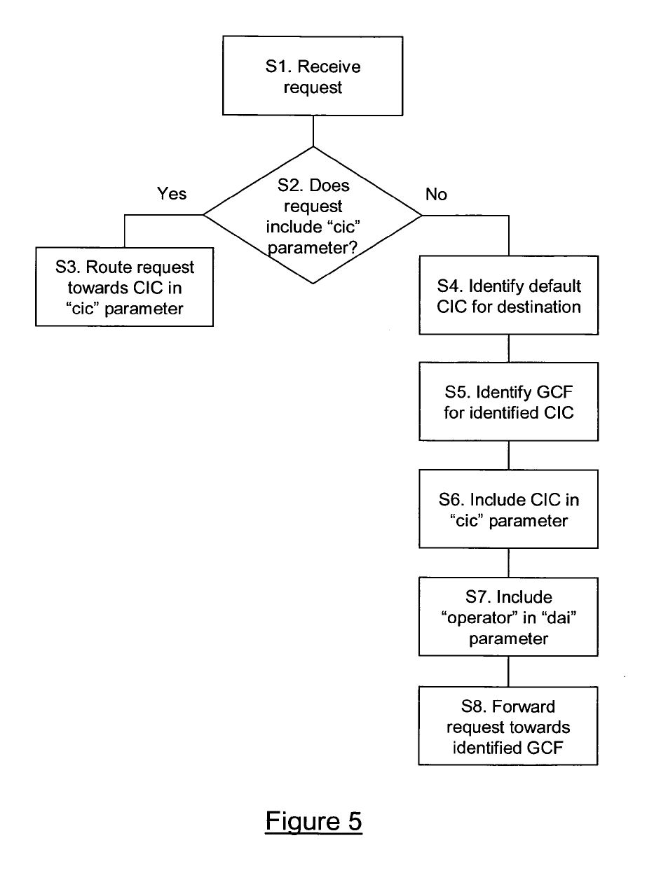

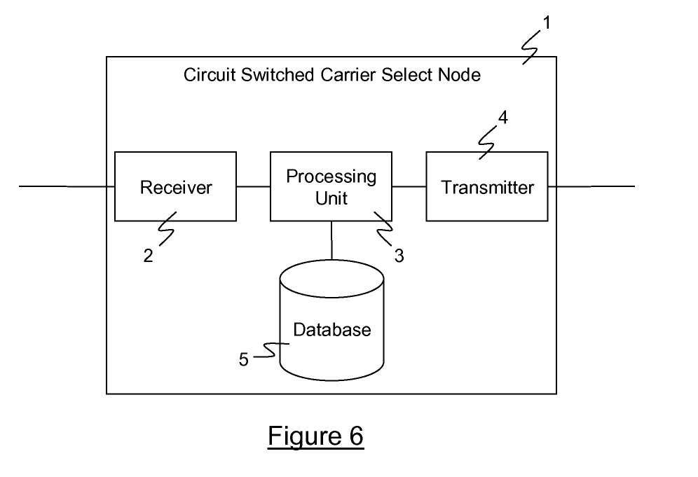

FIG. 5 is a flow diagram illustrating implemented by a BGCF to identify a default preferred circuit carrier, and the resources attached to the default preferred circuit carrier's network. The steps performed are as follows:
S1. The BGCF receives a session establishment request.
S2. The BGCF then determines if the request includes the “cic” parameter, and therefore a CIC identifying a preferred circuit switched carrier.
S3. If the request does include a CIC in the “cic” parameter, then the BGCF routes the request towards the circuit switched network identified by the CIC according to its usually routing methods. For example, the BGCF may have a table mapping each CIC to the appropriate MGCF/BGCF for performing breakout.
S4. If the request does not include a CIC in the “cic” parameter, then the BGCF identifies a CIC for the default circuit switched carrier of the intended destination of the request.
S5. The BGCF then identifies an MGCF/BGCF responsible for a MGW connected to the circuit switched network identified by the CIC from step S4.
S6. The BGCF then includes the CIC from step S4 in the “cic” parameter of the request.
S7. The BGCF also populates the “dai” parameter of the request with “operator”.
S8. The BGCF then forwards the request towards the MGCF/BGCF identified in step S5.

FIG. 6 illustrates schematically an example of a circuit switched carrier select node 1 suitable for implementing the method described above. The circuit switched carrier select node 1 can be implemented as a combination of computer hardware and software. The circuit switched carrier select node 1 comprises a receiver 2 for receiving a session establishment request, a processing unit 3 for identifying a circuit switched carrier for the intended destination of the request, identifying a BGCF or MGCF responsible for a MGW connected to the identified circuit switched carrier, including an identifier for the identified circuit switched carrier in the request; and a transmitter 4 for forwarding the request towards the identified BGCF or MGCF.

The circuit switched carrier select node 1 may further comprise a database 5 including a mapping of destinations to circuit switched carriers, and a mapping of circuit switched carriers to one or more BGCFs or MGCFs responsible for an MGW connected to the circuit switched network of the circuit switched carriers. The circuit switched carrier select node 1 could be a BGCF.

It will be appreciated by the person of skill in the art that various modifications may be made to the above-described embodiments without departing from the scope of the present invention. For example, whilst the embodiments described above include the use of the calling party table and a called party table, the BGCF may simply map destinations to the resources attached to the destination network. In addition, whilst the methods described above have been described with regards to the functions being performed at a BGCF, all of these functions could equally be performed at any other suitable node.

1. A method of routing a call from a first network to a second network, wherein the second network is a circuit switched network, the method comprising:
at a circuit switched carrier select node of the first network, receiving a session establishment request having an intended destination, wherein the session establishment request does not include a circuit switched carrier identifier;
identifying a circuit switched carrier for the intended destination of the session establishment request;
identifying a gateway control node responsible for a gateway node connected to the circuit switched network of the identified circuit switched carrier;
including in the session establishment request a circuit switched carrier identifier for the identified circuit switched carrier; and
forwarding the session establishment request towards the gateway control node.

2. The method as claimed in claim 1, wherein the step of identifying a circuit switched carrier for the intended destination of the request comprises performing a lookup in a database, the database comprising a mapping of destinations to circuit switched carriers.

3. The method as claimed in claim 2, wherein the step of identifying a gateway control node connected to the identified circuit switched carrier comprises performing a lookup in the database, the database further comprising a mapping of circuit switched carriers to one or more gateway control nodes connected to the circuit switched network of the circuit switched carriers.

4. The method as claimed in claim 1, further comprising:
at the circuit switched carrier select node, including an indicator that the identified circuit switched carrier included in the request was selected by the operator of the first network.

5. The method as claimed in claim 1, wherein the circuit switched carrier identifier is a Carrier Identification Code (CIC).

6. The method as claimed in claim 5, wherein the step of including a circuit switched carrier identifier for the identified circuit switched carrier in the request comprises including a “cic” parameter in a request-URI of the request, and setting the “cic” parameter to the Carrier Identification Code of the identified circuit switched carrier.

7. The method as claimed in claim 4, wherein the step of including an indicator that the identified circuit switched carrier included in the request was selected by the operator of the first network comprises including a “dai” parameter in a request-URI of the request, and setting the “dai” parameter to “operator”.

8. The method as claimed in claim 1, wherein the circuit switched carrier select node is a Border Gateway Control Function.

9. The method as claimed in claim 1, wherein the first network is an IP Multimedia Subsystem network and the gateway control node is a Media Gateway Control Function in the IP Multimedia Subsystem network.

10. A method as claimed in claim 1, wherein the gateway control node is a Border Gateway Control Function in a third network.

11. An apparatus for routing a call from a first network to a second network, wherein the second network is a circuit switched network, the apparatus comprising:
a receiver for receiving a session establishment request, the session establishment request having an intended destination;
a processing unit for identifying a circuit switched carrier for the intended destination of the session establishment request, identifying a gateway control node responsible for a gateway node connected to the identified circuit switched carrier, including a circuit switched carrier identifier for the identified circuit switched carrier in the session establishment request; and
a transmitter for forwarding the session establishment request towards the identified gateway control node.

12. The apparatus as claimed in claim 11, further comprising a database, the database comprising a mapping of destinations to circuit switched carriers.

13. The apparatus as claimed in claim 12, wherein the database further comprises a mapping of circuit switched carriers to one or more gateway control nodes connected to the circuit switched network of the circuit switched carriers.

14. An The apparatus as claimed in claim 11, wherein the apparatus is a Border Gateway Control Function.
